(19) United States
(12) Patent Application Publication
(10) Pub. No.: US 2018/0117815 A1
(43) Pub. Date: May 3, 2018

(54) METHOD FOR MANUFACTURING MOLDED PRODUCT

(71) Applicant: CANON KABUSHIKI KAISHA, Tokyo (JP)

(72) Inventor: Hirotaka Miyazaki, Yokohama-shi (JP)

(21) Appl. No.: 15/793,231

(22) Filed: Oct. 25, 2017

(30) Foreign Application Priority Data
Oct. 28, 2016 (JP) 2016-211909

(51) Int. Cl. B29C 45/76; B29C 45/56; B29C 45/17; B29C 45/00; B29C 45/16; B29C 45/14

(52) U.S. Cl. CPC B29C 45/762; B29C 45/561; B29C 45/1742; B41J 2/1601; B29C 45/1618; B29C 45/14311; B29C 45/0046

(57) ABSTRACT

A method for continuously manufacturing molded products by repeating a plurality of molding cycles includes, in each molding cycle, filling a resin composition into a mold, pressing the resin composition in the mold, cooling the resin composition in the mold using cooling water, and releasing the resin composition from an interior of the mold to obtain a molded product. An A-th molding cycle of the plurality of molding cycles can be a delay cycle delayed from a B-th molding cycle. When the A-th cycle is the delay cycle, the flow rate of the cooling water flowing in the mold at the cooling step is decreased in the A-th cycle as compared with the B-th cycle.

### BACKGROUND OF THE INVENTION

### Field of the Invention

The present disclosure relates to a method for manufacturing a molded product.

### Description of the Related Art

Molded products produced by injection molding are used for various applications. One example is an inkjet print head. FIGS. 7A to 7C illustrate an inkjet print head 10. The inkjet print head 10 includes a printing element substrate 1 including ejection ports that eject ink and a support member 2 which is a molded product produced by injection molding. The printing element substrate 1 is supported and fixed by the support member 2. The inkjet print head 10 further includes an electrical wiring member 3 and a joint member 4 that joins the printing element substrate 1 and the support member 2 together. FIG. 7A is a diagram of the inkjet print head 10 before the above components are fixed together. FIG. 7B is a diagram after the components are fixed together. FIG. 7C is a diagram illustrating the inkjet print head 10 in FIG. 7B viewed from a different angle.

In fixing the printing element substrate 1 to the support member 2, the printing element substrate 1 is sucked and held with a positioning jig, is then moved to a position of the support member 2, and is fixed thereto via the joint member 4 disposed on the support member 2. As described above, the support member 2 may be a molded product produced by injection molding from the viewpoint of cost, processability, etc. The joint member 4 is mainly formed of a thermosetting resin. In this case, the printing element substrate 1 is brought into contact with the joint member 4 above the support member 2, and the joint member 4 is cured by applying heat to fix the printing element substrate 1 to the support member 2.

The printing element substrate 1 may be as small as possible in the viewpoint of cost reduction. Reducing the size of the printing element substrate 1 decreases the width of an ink channel 5 for supplying ink into the printing element substrate 1. Therefore, if placement accuracy when placing the printing element substrate 1 on the support member 2 varies widely, the adhesive may run out to the ink channel 5 in the support member 2. The runout of the adhesive to the ink channel 5 interferes with the flow of ink supplied through the support member 2 to the printing element substrate 1, affecting ink ejection from the printing element substrate 1. To reduce the amount of runout of the adhesive to the ink channel 5, the amount of the adhesive may be decreased, for example, by decreasing the height of the adhesive disposed on the support member 2. However a lack of the adhesive can cause the ink to leak to the outside.

In this respect, Japanese Patent Laid-Open No. 2012-240210 discloses protrusions formed on a joint surface between the support member 2 and the printing element substrate 1 for bonding the printing element substrate 1 and the support member 2 to each other with an adhesive. This method prevents the adhesive from excessively squashing owing to the protrusions when the printing element substrate 1 is fixed to the support member 2 with the adhesive, reducing its tendency to protrude into the ink channel 5.

### SUMMARY OF THE INVENTION

The present disclosure provides a method for continuously manufacturing molded products by repeating a plurality of molding cycles. Each of the plurality of molding cycles includes filling a resin composition into a mold, pressing the resin composition in the mold, cooling the resin composition in the mold using cooling water, and releasing the resin composition from an interior of the mold to obtain a molded product. Assuming that one molding cycle of the plurality of molding cycles is an A-th molding cycle, and another molding cycle different from the A-th molding cycle is a B-th molding cycle, the A-th molding cycle can be a delay cycle delayed from the B-th molding cycle. When the A-th cycle is the delay cycle, a flow rate of the cooling water flowing in the mold at the cooling step is decreased in the A-th cycle as compared with the B-th cycle.

Further features of the present disclosure will become apparent from the following description of exemplary embodiments with reference to the attached drawings.

### BRIEF DESCRIPTION OF THE DRAWINGS

FIG. 1 is a flowchart illustrating a method for manufacturing a molded product according to an embodiment of the present disclosure.

FIG. 2 is a schematic diagram illustrating the temperature of a mold during a molding process.

FIG. 3 is a schematic diagram. illustrating the relationship between molded-produce molding cycles and cooling water control.

FIG. 4 is a flowchart illustrating a method for manufacturing a molded product according to an embodiment of the present disclosure.

FIG. 5 is a schematic diagram illustrating the timing when a molding-material measuring step of each cycle.

FIG. 6 is a conceptual diagram of molding using an injection molding apparatus.

FIG. 7A is a diagram illustrating an inkjet print head before the above components are fixed together.

FIG. 7B is a diagram illustrating the inkjet print head the after the components are fixed together.

FIG. 70 is a diagram illustrating the inkjet print head in FIG. 7B viewed from a different angle.

### DESCRIPTION OF THE EMBODIMENTS

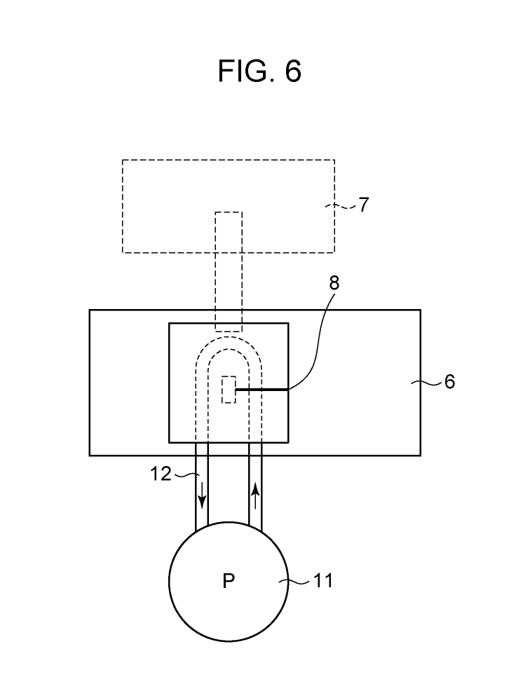

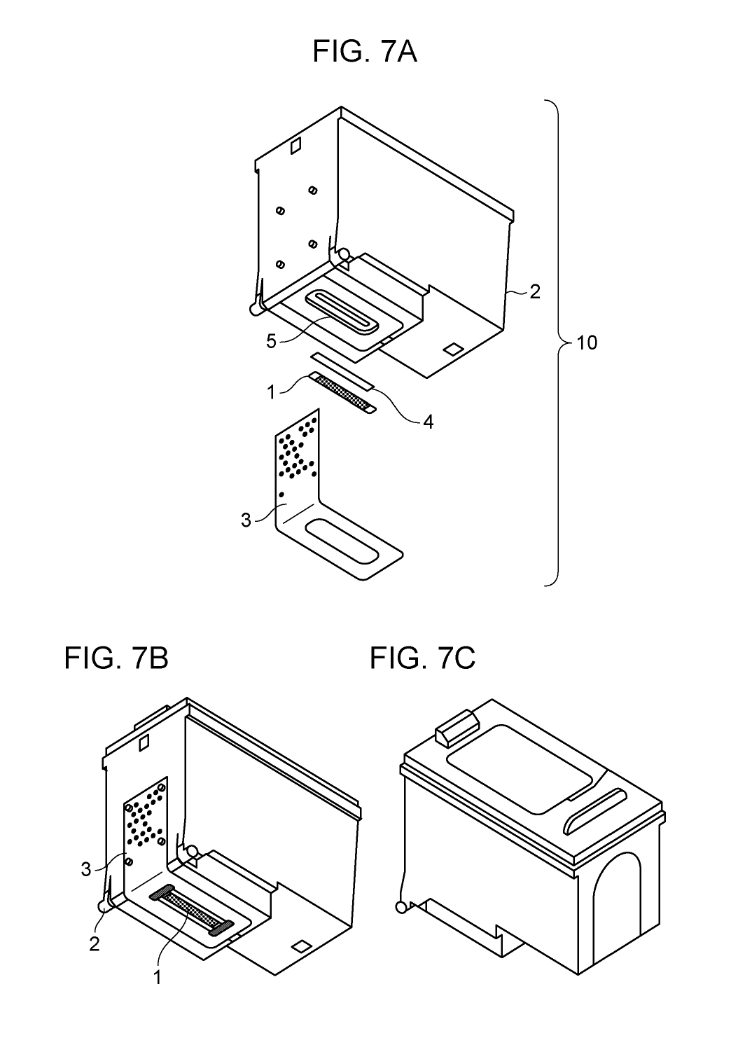

Molded products are often used as support members or other articles in the viewpoint of cost and processability. FIG. 6 is a conceptual diagram of molding using an injection molding apparatus. An injection molding apparatus 6 contains a resin filled unit 8. An annealing apparatus 7 is disposed above the injection molding apparatus 6. A cooling-water circulation apparatus 11 and a cooling-water circulation channel 12 are disposed below the injection molding apparatus 6. In general, molding using the injection molding apparatus 6 needs stabilizing time for stabilizing the dimensional accuracy at the start-up of the injection molding apparatus 6. A support member 2 having undesired dimensional accuracy molded during the stabilizing time is discarded. Therefore, when start-up and shut-down of the injection molding apparatus 6 are frequently repeated, a large number of support members 2 having undesired dimensional accuracy are produced, resulting in an increase in component cost correspondingly. For that reason, in normal molding, the injection molding apparatus 6 is not stopped until a necessary number of support members 2 are produced.

After the molding process performed by injection molding, various processes may be continuously performed to manufacture molded products. For example, since the support member 2 directly after being molded is at high temperature, the support member 2 changes in size when the temperature decreases to a room temperature (25° C.). For that reason, a process (annealing process) for stabilizing the size of the molded support member 2 is connected to the molding process of the support member 2. In FIG. 6, the annealing apparatus 7 is provided to stabilze the size of the support member 2. In addition, a bonding process for bonding a separate member to the molded support member 2 may be connected to the molding process.

The inventors examined stopping the injection molding apparatus 6 when the manufacture fails at a process other than the molding process performed by the injection molding apparatus 6 in the case where another process is connected to the molding process, as described above. However, if such a problem occurs frequently in a process other than the molding process in the injection molding apparatus 6, the start-up and the shut-down of the injection molding apparatus 6 are frequently repeated each time. This causes a large number of support member 2 having undesired dimensional accuracy, increasing the manufacturing cost of the molded products. Such a problem is likely to occur when the molded products are support members of inkjet print heads but can occur in general molded products.

The present disclosure provides a method for manufacturing a molded product in which a large number of molded products having undesired dimensional accuracy are produced even when molded products are continuously manufactured.

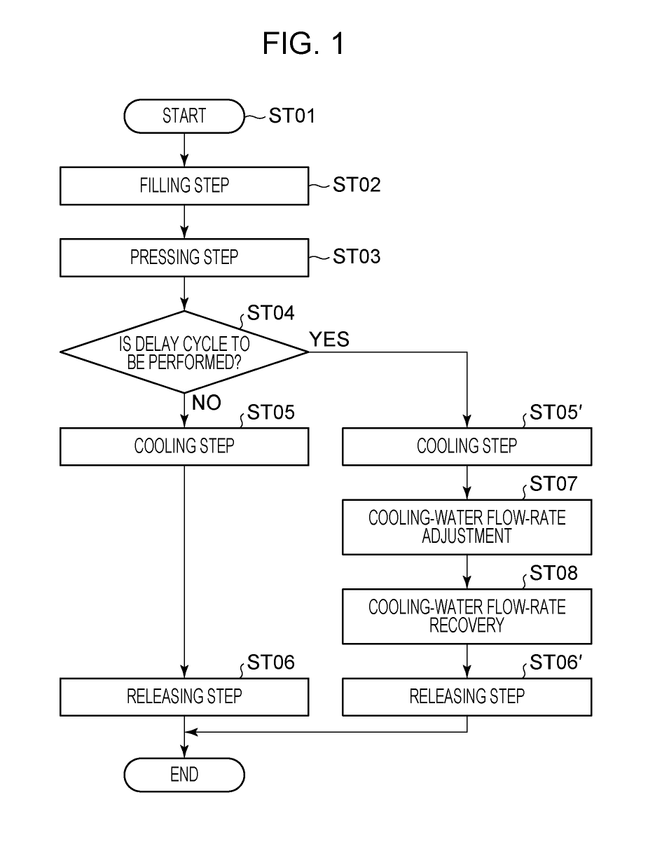

FIG. 1 is a flowchart illustrating a method for manufacturing a molded product according to an embodiment of the present disclosure. The flowchart illustrated in FIG. 1 shows the sequence of steps performed during one molding cycle by the injection molding apparatus 6. In an embodiment of the present disclosure, such a molding cycle is repeated a plurality of times to continuously manufacture molded products. If something happens except in the injection molding process, the molding process is not stopped but a cycle corresponding the problem is delayed (a delay cycle). In the delay cycle, cooling water is controlled to decrease in flow rate. This will be specifically described using an example in which a support member for supporting a printing element substrate of an inkjet print head is manufactured as a molded product.

As illustrated in FIG. 1, when molding is started at a starting step (ST01), first a filling step (ST02) of pouring a resin composition, which is a molding material, into a mold to fill the interior of the mold is performed. Subsequently, a pressing step (ST03) of pressing the resin composition in the mold is performed to distribute the resin composition to every corner in the mold, thereby increasing the molding density of the resin composition.

Next, it is determined whether a delay cycle it to be executed (ST04). Of a plurality of molding cycles, a certain molding cycle is referred to as “A-th molding cycle”, and a molding cycle different from the certain molding cycle is referred to as “B-th molding cycle”. To delay the timing of completion of molding by taking longer time for the A-th molding cycle than for the B-th molding cycle is referred to as “execution of a delay cycle”. The delay cycle is executed not to stop the molding cycle, for example, when a step following the molding process cannot be smoothly executed. The delay cycle is not limited to one cycle; a plurality of delay cycles may be performed. The B-th cycle may be each cycle repeated under the same conditions at the normal continuous manufacture of the molded products (one of the normal cycles). Hereinafter, the A-th cycle will be described as a delay cycle, and the B-th cycle will be described as a normal cycle.

In the case where the delay cycle is not performed, that is, in the normal cycle, a cooling step (ST05) of cooling the resin composition in the mold is performed, and thereafter a releasing step (ST06) of releasing the resin composition from the mold is performed to obtain a molded product.

In the case where the delay cycle is performed, a cooling-water flow-rate adjustment (ST07) for decreasing the flow rate of the cooling water to stabilize the mold temperature and a cooling-water flow-rate recovery (ST08) are performed between a cooling step (ST05′) and a releasing step (ST06′). In other words, in the A-th cycle, or the delay cycle, the flow rate of the cooling water flowing in the mold in the cooling step is made lower than that in the B-th cycle different from the A-th cycle. The B-th cycle may not necessarily be the normal cycle, but is often the normal cycle.

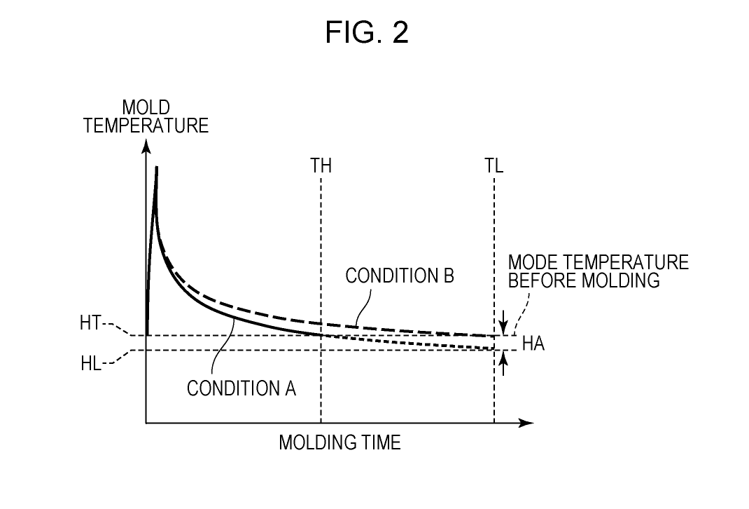

The reason why the flow rate of the cooling water is decreased will be described with reference to FIG. 2.

FIG. 2 is a schematic diagram illustrating the temperature of the mold during the molding process. Both of condition A and condition B are of a case where, for example, the time taken for the molding cycle is delayed owing to the influence of another step, that is, the delay cycle is performed. Under the condition A, the flow rate of the cooling water is not decreases, and under the condition B, the flow rate of the cooling water is decreased. When the flow rate of the cooling water is not decreased as under the condition A, the temperature of the mold increased owing to the filling step (ST02) decreases with time to reach HT at a normal cycle end time (TH). The temperature of the mold further decreases to HL at a delay-cycle end time (IL). Since the state of the mold at the start of the molding process differs by an amount corresponding to the difference HA between HT and HL, the dimensional accuracy of the support member decreases. This makes the dimensional accuracy of the molded product undesirable.

In contrast, when the flow rate of the cooling water is decreased by controlling the cooling water in the delay cycle as under the condition B, a decrease in mold temperature at the time TL can be reduced so that the temperature can be made as close as possible to HT or substantially the same value. In other words, HA can be decreased or made substantially zero, so that a molded product having high dimensional accuracy can be obtained.

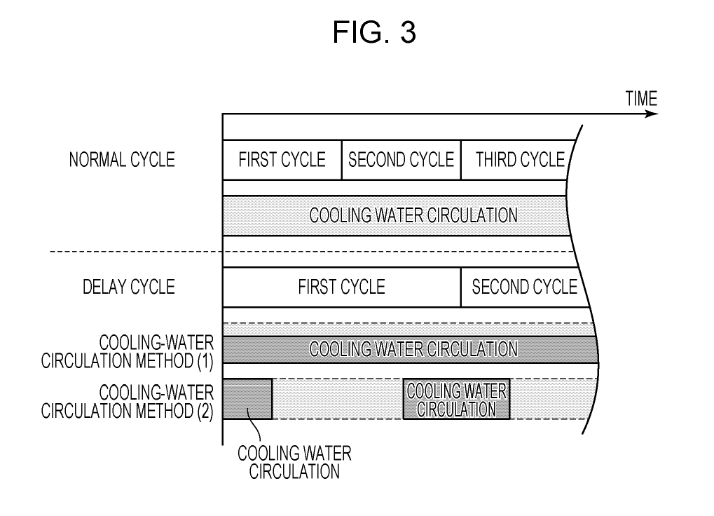

FIG. 3 is a schematic diagram illustrating a method for decreasing the flow rate of the cooling water in the delay cycle, in which the larger the vertical widths of the portions representing circulation of the cooling water, the higher the flow rate of the cooling water. There are roughly two method for decreasing the flow rate of the cooling water. One is a cooling-water circulation method (1), which is a method for decreasing the flow rate although not stopping the cooling water, in which the flow rate of the cooling water is made lower in the delay cycle than the flow rate in the normal cycle indicated by the dotted line. The other is a cooling-water circulation method (2), which is a method of temporarily stopping the cooling water flowing in the mold. In this method, a time during which the flow of the cooling water is stopped is provided in the delay cycle as compared with the flow rate of the cooling water in the normal cycle indicated by the dotted line.

The result of actual examination will be described in which the relation between the normal-cycle end time (TH) and the delay-cycle end time (TL) was TL=2TH as the condition B in FIG. 2 and the cooling-water circulation method (2) in FIG. 3 was selected for adjustment of the flow rate of the cooling water. The time to start to stop the cooling water was after completion of the pressing step (ST03) so that the environment in filling resin into the mold is the same between the normal cycle and the delay cycle. When the time to stop the cooling water flowing in the mold was set to TL×¾, the difference in mold temperature, (HA), between the normal-cycle end time (TH) and the delay-cycle end time(TL) was less than 3° C., which shows that the dimensional accuracy of the molded product is very high.

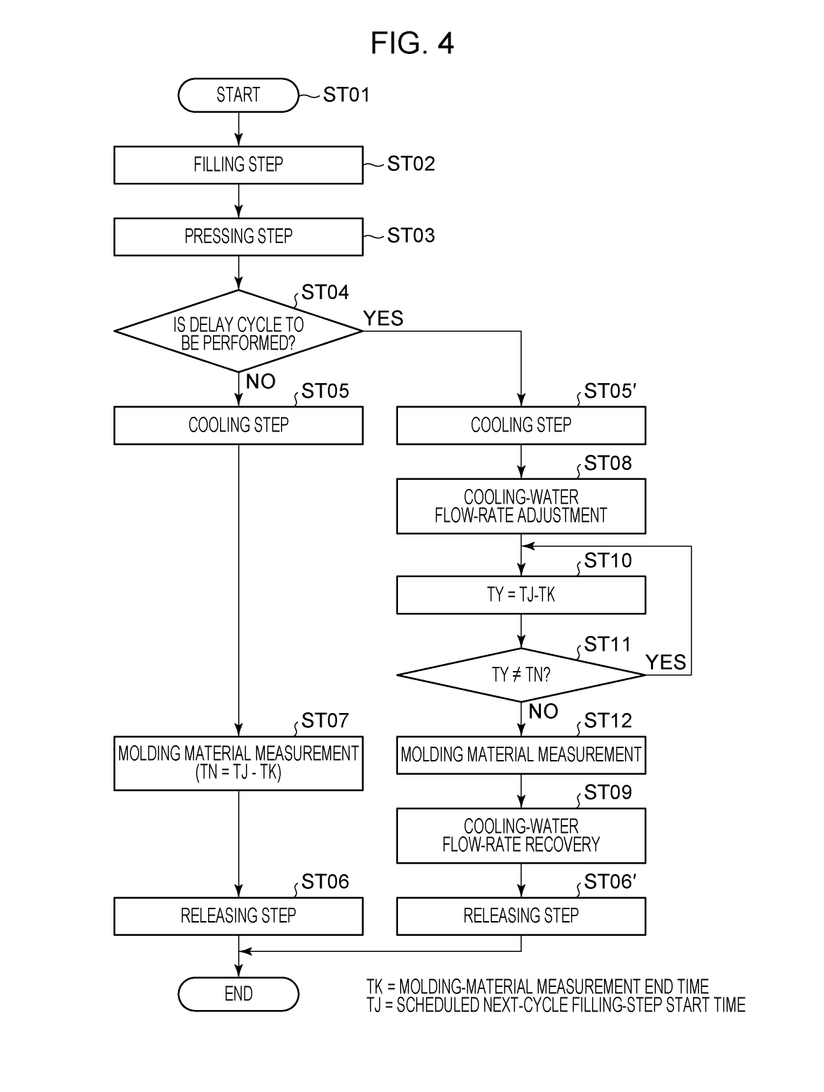

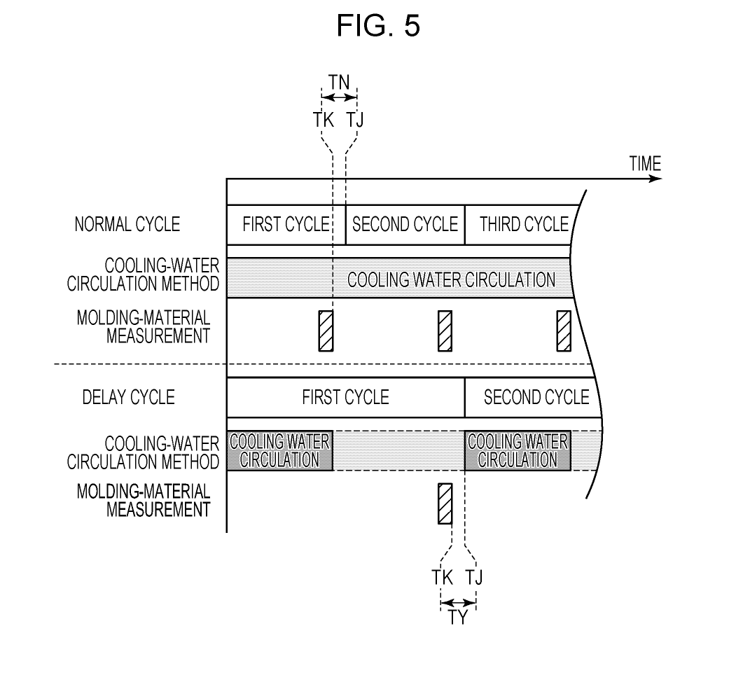

Referring next to FIGS. 4 and 5, the relationship between the delay cycle and measurement of a molding material will be described. FIG. 4 is a flowchart illustrating the sequence of steps executed by the injection molding apparatus 6 during one molding cycle. FIG. 5 is a schematic diagram illustrating a comparison between the normal cycle and the delay cycle for the timing of execution of a molding-material (resin-composition) measuring step for each molding cycle. The measuring step is a step of measuring the amount of resin composition (molding material) filled at the filling step.

Referring to FIGS. 4 and 5, when molding is started at the starting step (ST01), as in the step described for FIG. 1, the filling step (ST02) of filling the resin composition, or the molding material, into the mold is performed. Subsequently, a pressing step (ST03) of pressing the resin composition in the mold is performed to distribute the resin composition to every corner in the mold, thereby increasing the molding density of the resin composition.

Next, it is determined whether a delay cycle it to be executed (ST04). In the case where the delay cycle is not performed, that is, in the normal cycle, a cooling step (ST05) of cooling the resin composition is performed, and thereafter a releasing step (ST06) of releasing the resin composition from the mold is performed. Meanwhile, the time difference TN between the scheduled time TJ to start. the filling step of the next cycle and the time TK at which a molding-material measuring step (ST07) of preparing a molten resin compositon to be used in the next cycle is calculated. Here, the measuring step (ST07) is performed between the cooling step (ST05) and the releasing step (ST06). Alternatively, the cooling step (ST05) may be performed after the measuring step (ST07). As another alternative, the measuring step (ST07) may be performed after the releasing step (ST06).

In the case where the delay cycle is performed, a cooling-water flow-rate adjustment (ST08) for stabilizing the mold temperature and a cooling-water flow-rate recovery (ST09) are performed between a cooling step (ST05′) and a releasing step (ST06′). Furthermore, as shown in (ST10), (ST11), and (ST12), the time to start a molding-material measuring step (ST12) of preparing a molten resin composition to be used in the next cycle is calculated. The start time of the molding-material measuring step (ST12) is set so that the time difference TY between the scheduled time TJ to start the filling step in the next cycle and the end time of the molding-material measuring step (ST12) is the same as the time difference TN of the normal cycle. The time to start the molding-material measuring step (ST12) in the delay cycle may be set in advance to any value that satisfies TY≈TN. Controlling the timing of the measuring step in this way allows the interval from the end time of the molding-material measuring step (ST07) to the start time of the filling step (ST02) of the next cycle of the normal cycle and the interval from the end time of the molding-material measuring step (ST12) to the start time of the filling step (ST02) of the next cycle of the delay cycle to be controlled to be constant (TY=TN). Furthermore, the interval from the measuring-step end time to the start time of the filling step of the next cycle can be controlled to be constant in a plurality of molding cycles. The term “constant” means that the interval is constant without consideration of a difference due to a manufacturing error etc. This reduces an influence of thermal degradation of the resin composition, thereby further stabilizing the dimensional accuracy of the molded product.

Here, the steps (ST10), (ST11), and (ST12) are performed between the cooling-water flow-rate adjustment (ST08) and the cooling-water flow-rate recovery (ST09). Alternatively, after the steps (ST10), (ST11), and (ST12), the cooling-water flow-rate adjustment (ST08) may be performed. The measuring step (ST12) may be performed within one minute from the start of the filling step of the next cycle. This is because leaving the measured resin for a time longer than one minute can degrade the resin.

The flow rate of the cooling water may be decreased either before the filling step or after the filling step. The flow rate of the cooling water may be decreased either before the pressing step or after the pressing step. In other words, the flow rate of the cooling water may be decreased in the cooling water flow-rate adjusting step after the filling step and the pressing step in one molding cycle.

The period during which the flow rate of the cooling water is decreased may be increased as the duration of the molding cycle increases. In the case where the cooling water is stopped, the period during which the cooling water is stopped is increased as the duration of the molding cycle increases. This further increases the molding accuracy of the molded product. The cooling water to be controlled may not necessarily be circulated but may be flowing in one direction.

In this way, production of a large number of molded products having undesired dimensional accuracy is prevented even when molded products are continuously manufactured.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-211909 filed Oct. 28, 2016, which is hereby incorporated by reference herein in its entirety.

What is claimed is:

1. A method for continuously manufacturing molded products by repeating a plurality of molding cycles, each of the plurality of molding cycles comprising:
filling a resin composition into a mold;
pressing the resin composition in the mold;
cooling the resin composition in the mold using cooling water; and
releasing the resin composition from an interior of the mold to obtain a molded product,
wherein, assuming that one molding cycle of the plurality of molding cycles is an A-th molding cycle, and another molding cycle different from the A-th molding cycle is a B-th molding cycle, the A-th molding cycle can be a delay cycle delayed from the B-th molding cycle, and
wherein, when the A-th cycle is the delay cycle, a flow rate of the cooling water flowing in the mold at the cooling step is decreased in the A-th cycle as compared with the B-th cycle.

2. The method for continuously manufacturing a molded product according to claim 1, wherein, when the A-th cycle is the delay cycle, a flow of the cooling water is not stopped in the A-th cycle.

3. The method for continuously manufacturing a molded product according to claim 1, wherein, when the A-th cycle is the delay cycle, a flow of the cooling water is stopped in the A-th cycle.

4. The method for continuously manufacturing a molded product according to claim 1, wherein, in the A-th cycle, the flow rate of the cooling water flowing in the mold is decreased after the filling step.

5. The method for continuously manufacturing a molded product according to claim 2, wherein, in the A-th cycle, the flow rate of the cooling water flowing in the mold is decreased after the filling step.

6. The method for continuously manufacturing a molded product according to claim 3, wherein, in the A-th cycle, the flow rate of the cooling water flowing in the mold is decreased after the filling step.

7. The method for continuously manufacturing a molded product according to claim 1, wherein, in the A-th cycle, the flow rate of the cooling water flowing in the mold is decreased after the pressing step.

8. The method for continuously manufacturing a molded product according to claim 2, wherein, in the A-th cycle, the flow rate of the cooling water flowing in the mold is decreased after the pressing step.

9. The method for continuously manufacturing a molded product according to claim 3, wherein, in the A-th cycle, the flow rate of the cooling water flowing in the mold is decreased after the pressing step.

10. The method for continuously manufacturing a molded product according to claim 1, wherein, in the A-th cycle, the flow rate of the cooling water flowing in the mold is decreased between the cooling step and the releasing step.

11. The method for continuously manufacturing a molded product according to claim 2, wherein, in the A-th cycle, the flow rate of the cooling water flowing in the mold is decreased between the cooling step and the releasing step.

12. The method for continuously manufacturing a molded product according to claim 3, wherein, in the A-th cycle, the flow rate of the cooling water flowing in the mold is decreased between the cooling step and the releasing step.

13. The method for continuously manufacturing a molded product according to claim 1, each of the plurality of molding cycles further comprising the step of:
measuring an amount of the resin composition to be filled in the filling step of a next cycle,
wherein an interval from a measuring-step end time to a filling-step start time of a next cycle is controlled so as to be constant between the A-th cycle and the B-th cycle by controlling timing of the measuring step.

14. The method for continuously manufacturing a molded product according to claim 2, each of the plurality of molding cycles further comprising the step of:
measuring an amount of the resin composition to be filled in the filling step of a next cycle,
wherein an interval from a measuring-step end time to a filling-step start time of a next cycle is controlled so as to be constant between the A-th cycle and the B-th cycle by controlling timing of the measuring step.

15. The method for continuously manufacturing a molded product according to claim 3, each of the plurality of molding cycles further comprising the step of:
measuring an amount of the resin composition to be filled in the filling step of a next cycle,
wherein an interval from a measuring-step end time to a filling-step start time of a next cycle is controlled so as to be constant between the A-th cycle and the B-th cycle by controlling timing of the measuring step.

16. The method for continuously manufacturing a molded product according to claim 13, wherein the interval from the measuring-step end time to the filling-step start time of the next cycle is controlled so as to be constant among the plurality of cycles by controlling the timing of the measuring step.

17. The method for continuously manufacturing a molded product according to claim 14, wherein the interval from the measuring-step end time to the filling-step start time of the next cycle is controlled so as to be constant among the plurality of cycles by controlling the timing of the measuring step.

18. The method for continuously manufacturing a molded product according to claim 15, wherein the interval from the measuring-step end time to the filling-step start time of the next cycle is controlled so as to be constant among the plurality of cycles by controlling the timing of the measuring step.

19. The method for continuously manufacturing a molded product according to claim 13, wherein the measuring step is performed at a timing within one minute until the start of the filling step of the next cycle.

20. The method for continuously manufacturing a molded product according to claim 16, wherein the measuring step is performed at a timing within one minute until the start of the filling step of the next cycle.
